(19) United States
(12) Patent Application Publication
(10) Pub. No.: US 2012/0284622 A1
(43) Pub. Date: Nov. 8, 2012

(54) CONTEXT-SENSITIVE MOBILE CONTROLLER FOR MEDIA EDITING SYSTEMS

(76) Inventors: Ryan L. Avery, San Francisco, CA (US); Stephen Crocker, Tyngsboro, MA (US); Paul J. Gray, Cambridge, MA (US)

(21) Appl. No.: 13/102,458

(22) Filed: May 6, 2011

(51) Int. Cl. G06F 3/048

(52) U.S. Cl. 715/719; 715/716

(57) ABSTRACT

Methods and systems for providing media editing capability to a user of a mobile device in communication with a video or an audio media editing system. The methods involve receiving at the mobile device information specifying a current user context of the media editing system and automatically activating functionality on the mobile device that corresponds to the current editing context. The functionality may be a subset of the editing system controls, controls associated with a plug-in software module, or new controls or control modalities enabled by the form factor and input modes featured on the mobile device. The functionality of the mobile device may be updated as the editing context changes, or temporarily frozen to enable multi-user work flows, with each user using a different editing function.

### BACKGROUND

Media editing systems continue to evolve by expanding the number and scope of features offered to users. For example, in a digital audio workstation, users can interact with transport, track volume, pan, mute, solo controls, as well as many other operations, such as save and undo. Each group of controls is located in a different part of the user interface, and as their number increases, the result is an increasingly crowded interface. Interacting with all these elements with a mouse can be frustrating for the user because some of the functions need to be relegated to small buttons, which require precise mouse movements to hover over and select.

In addition, for all but the simplest of projects, media composition workflows usually involve several different people playing different roles. Not all the roles require the full media editing functionality. For example, when a producer needs to review the script of a video composition, it may be sufficient to provide text viewing and editing functionality without video editing, or even, in some cases, video viewing capability. There is a need to support such workflows.

### SUMMARY

An application running on a mobile device that is in communication with a media editing system provides a second, context-sensitive means of interacting with the editing system. Subsets of interactions that are enabled on the media editing system may be activated on the mobile device based on a user context on the editing system. In addition, new functionality or new modes of interaction may be implemented by the mobile device application to take advantage of the form factor and user interaction interfaces of the mobile device.

In general, in one aspect, a method of providing media editing capability to a user of a mobile device, wherein the mobile device is in communication with a media editing system, includes: receiving at the mobile device information specifying a current user context of the media editing system, wherein the current user context of the media editing system is defined by a first subset of functionality of the media editing system most recently selected by a user of the media editing system; and in response to receiving the information specifying the current user context of the media editing system: activating a second subset of functionality of the media editing system on the mobile device; displaying on a display of the mobile device a user interface for controlling the second subset of functionality of the media editing system; via the displayed user interface, receiving a media editing command from the user of the mobile device; and sending the media editing command from the mobile device to the media editing system, wherein in response to receiving the media editing command, the media editing system performs an action corresponding to the media editing command.

Various embodiments include one or more of the following features. The second subset of functionality is included within the first subset of functionality. At least a portion of the second subset of functionality is not included within the first subset of functionality. The mobile device includes a touch-sensitive display, and the portion of the second subset of functionality not included within the first subset of functionality involves touch input by the user of the mobile device. The mobile device receives the information specifying content from the media editing system via a direct wireless connection between the media editing system and the mobile device or via a Web server that receives information from the media editing system. The media editing system is a video editing system. The second subset of functionality of the media editing system includes one or more of: enabling the user of the mobile device to view information pertaining to a selected item in a bin of the media editing system; enabling the user of the mobile device to select on a timeline representation a cut point between a first clip and a second clip of a video sequence; enabling the user of the mobile device to select a portion of a script corresponding to a video program being edited on the media composition system, wherein selecting the portion of the script causes the media composition to display an indication of one or more clips corresponding to the selected portion of the script; enabling the user of the mobile device to perform color correction operations for a video program being edited on the media composition system; and enabling the user of the mobile device to define parameters for applying an effect to a video program being edited on the media composition system. The mobile device includes a touch-sensitive display, and the user is able to define the effect parameters by touching and dragging one or more effect control curves. The media editing system is a digital audio workstation. The subset of functionality that is activated on the mobile device includes one or more of channel transport functions, mixing functions, and track timeline editing functions. The functionality of the media editing system is augmented by a plug-in module, and the functionality activated on the mobile device includes functionality corresponding to the plug-in module. The user interface further includes a freeze control, such that if the current context of the media editing system is changed when the freeze control is selected, the user interface is not changed and the user interface continues to enable the user of the mobile device to control the first-mentioned subset of functionality of the media composition system from the mobile device.

In general, in another aspect, a computer program product includes: storage including instructions for a processor to execute, such that when the processor executes the instructions, a process for providing media editing capability to a user of a mobile device is performed, wherein the mobile device is in communication with a media editing system, the process comprising: receiving at the mobile device information specifying a current user context of the media editing system, wherein the current user context of the media editing system is defined by a first subset of functionality of the media editing system most recently selected by a user of the media editing system; and in response to receiving the information specifying the current user context of the media editing system: activating a second subset of functionality of the media editing system on the mobile device; displaying on a display of the mobile device a user interface for controlling the second subset of functionality of the media editing system; via the displayed user interface, receiving a media editing command from the user of the mobile device; and sending the media editing command from the mobile device to the media editing system, wherein in response to receiving the media editing command, the media editing system performs an action corresponding to the media editing command.

In general, in a further aspect, a mobile device includes: a processor for executing instructions; a network interface connected to the processor; a user input device connected to the processor; a display connected to the processor; a memory connected to the processor, the memory including instructions which, when executed by the processor, cause the mobile device to implement a process for providing media editing capability to a user of the mobile device, wherein the mobile device is in communication with a media editing system, the process comprising: receiving via the network interface information specifying a current user context of the media editing system, wherein the current user context of the media editing system is defined by a first subset of functionality of the media editing system most recently selected by a user of the media editing system; and in response to receiving the information specifying the current user context of the media editing system: activating a second subset of functionality of the media editing system on the mobile device; displaying on the display of the mobile device a user interface for controlling the second subset of functionality of the media editing system; via the displayed user interface and the input device, receiving a media editing command from the user of the mobile device; and via the network interface, sending the media editing command to the media editing system, wherein in response to receiving the media editing command, the media editing system performs an action corresponding to the media editing command.

### BRIEF DESCRIPTION OF THE DRAWINGS

FIGS. 1A and 1B are high level block diagrams of a media editing system with a context-sensitive mobile controller.

FIG. 2 is an illustration of a video editing system bin window with a bin item selected by the user.

FIG. 3 is an illustration of a mobile device display with the bin item information context activated.

FIG. 4 is an illustration of video editing system color controls selected by the user.

FIG. 5 is an illustration of a mobile device display with the color correction context activated.

FIG. 6 is an illustration of a digital audio workstation display with channel controls selected by the user.

FIG. 7 is an illustration of a mobile device display with the channel control context activated.

FIG. 8 is an illustration of a digital audio workstation display with the transport bar selected by the user.

FIG. 9 is an illustration of a mobile device display with the transport bar context activated.

FIG. 10 is an illustration of a video editing system timeline display in trim mode.

FIG. 11 is an illustration of a mobile display device with the timeline trim mode context activated.

FIG. 12 is an illustration of a video editing system script view with script view/search selected by the user.

FIG. 13 is an illustration of a mobile device display with script view/search mode activated.

FIG. 14 is an illustration of a portion of a digital audio workstation timeline window in which a compressor/limiter plug-in is selected by the user.

FIG. 15 is an illustration of the mobile device user interface for a compressor/limiter plug-in corresponding to the plug-in selected by the user as illustrated in FIG. 14.

### DETAILED DESCRIPTION

To address the problem of an increasingly crowded user interface and to facilitate multi-person workflows, a mobile device is used in conjunction with a media editing system. The mobile device is in bidirectional communication with the media editing system.

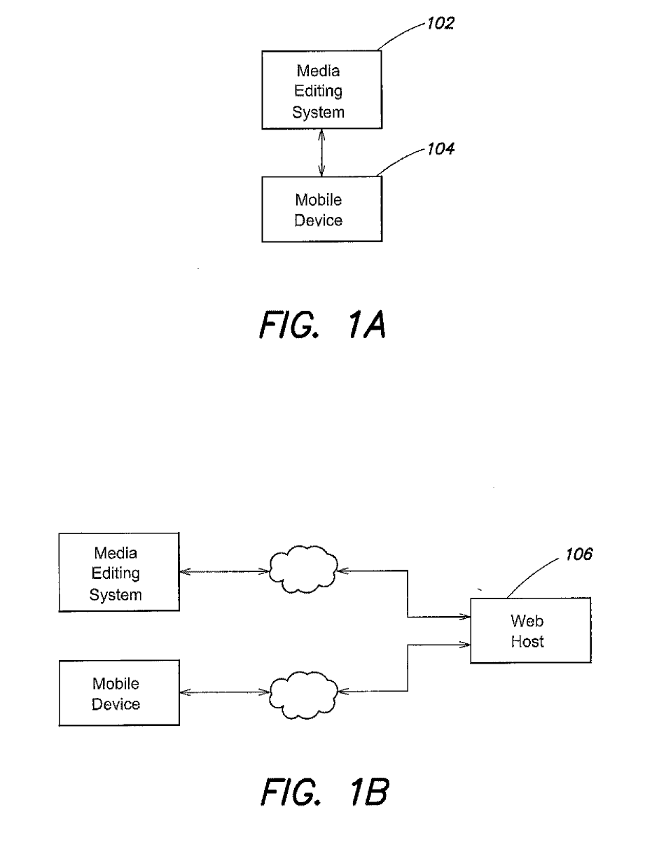

In various embodiments, the communication is mediated via a point to point connection, such as a wireless local area network implemented, for example, by a Wi-Fi network or by a Bluetooth connection. FIG. 1A shows such a system, with media editing system 102 and mobile device 104 having a direct bidirectional connection. Such a set-up requires the mobile device and the media editing system to be within wireless range of each other, which typically means within the same room, or at least within the same building. The mobile device may be used as a secondary interface by the user of the media editing system, or may be used by a second person who may be able to view the screen of the media editing system, and work collaboratively with the user of the editing system.

In other embodiments, the media editing system and the mobile device communicate via an intermediate web host, as indicated at 106 in FIG. 1B. In this arrangement, the messages to and from the editing system may use a different protocol and command set, with the Web host acting as a translator. For example with a media editing system that is a digital audio workstation, such as Pro Tools® from Avid Inc. of Burlington, Mass., the messages sent to web host 106 and received back from the web host conform to the OSC (Open Sound Control) protocol. The Web host, which in various embodiments implements a Ruby server, converts the OSC commands received from the digital audio workstation into a form that can be interpreted by the mobile device, such as JSON commands, and converts JSON commands received from the mobile device into OSC for sending onward to the digital audio workstation. In this configuration, there is no requirement that the mobile device and the media editing system be co-located. All that is required is that they each have an internet connection. This facilitates workflows in which a user requires only a subset of the editing system's functionality, but wishes to exercise that functionality in a specialized environment away from the main editing system. For example, a musician recording a performance on a digital audio workstation may activate a set of transport controls on the mobile device and take the device into a recording studio without the need to move the entire workstation, which may not be readily moved.

A key aspect of the assignment of functionality to the mobile device is the ability to switch functionality automatically according to a current editing context at the media editing system. Each of the sets of editing controls may define a context, for which a corresponding functionality is defined for the mobile device. This corresponding mobile device functionality may mirror the controls that define the context, or may be a subset, a superset, or a related but different set of functions. Each media editing context and its corresponding mobile device functionality can be pre-set or determined by the user. The editing context is defined, for example, by one or more of the current position of the mouse pointer in the editing system display or the location most recently clicked on, the current system state, and on-screen dialog boxes.

The media editing system continually tracks the user context, including, for example, the position of the mouse, and sends out a stream of messages specifying the current context. For point-to-point connections between the media editing system and the mobile device (FIG. 1A), the mobile device receives this stream, and activates (or leaves activated) a functionality set that has been assigned to the most recently received context. For connections mediated by a Web host (FIG. 1B), the Web host may send context updates at regular intervals, such as about 5-10 times a second, or may only send updates when the context changes, triggering the mobile device to activate a different functionality.

When more than one person is working simultaneously on a media composition, it may be desirable for the operator of the media editing system to be able to change context, while enabling a user of the mobile device to continue using controls corresponding to a previously active context. In order to facilitate such workflows, the mobile device application provides a “freeze” control, which is implemented, for example, by a button that toggles the mobile device between a frozen and un-frozen state. Note that all that is frozen is the functionality set that is activated on the mobile device; the mobile device remains active and responsive to user input in its currently activated (frozen) mode. One example use in which the freeze control is activated involves freezing transport controls on the mobile device for use by a producer, while enabling an engineer to perform minor clean-up operations on the main system. Another example involves freezing the UI of a plug-on on the mobile device. These examples are described in more detail below.

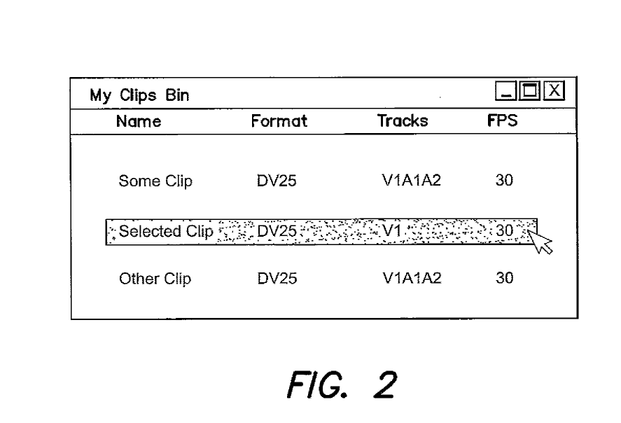

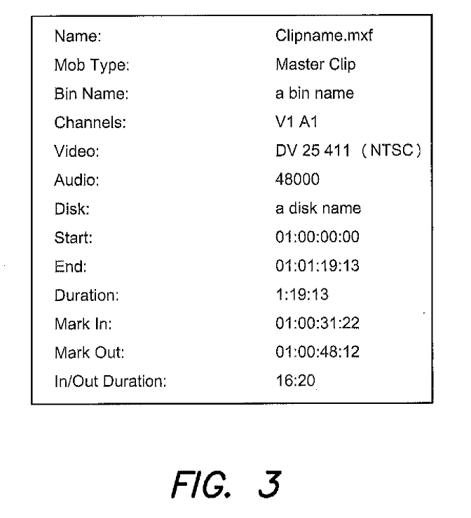

The provision of a mobile device as a secondary controller for a media editing system provides several different types of advantage. First, it can address the problem of the crowded interface referred to above. One way of reducing overcrowding and clutter is to gather and display information pertaining to the composition or a bin item on the mobile device. In the example shown in FIG. 2, which illustrates the bin window on the display of a video editing system such as Media Composer® from Avid Technology, Inc. of Burlington, Mass., described in part in U.S. Pat. Nos. 5,267,351 and 5,355,450, which are incorporated by reference herein, and Final Cut Pro® from Apple Computer, Inc. of Cupertino Calif., the user has selected a bin item by rolling over or clicking on an item. This action defines the bin context, and activates the corresponding mobile device functionality, which is an information pane on the highlighted bin item, as illustrated in FIG. 3. In an example involving an audio composition, such an information pane may include sample rate, bit depth, audio format, clock source, disk space, and system usage.

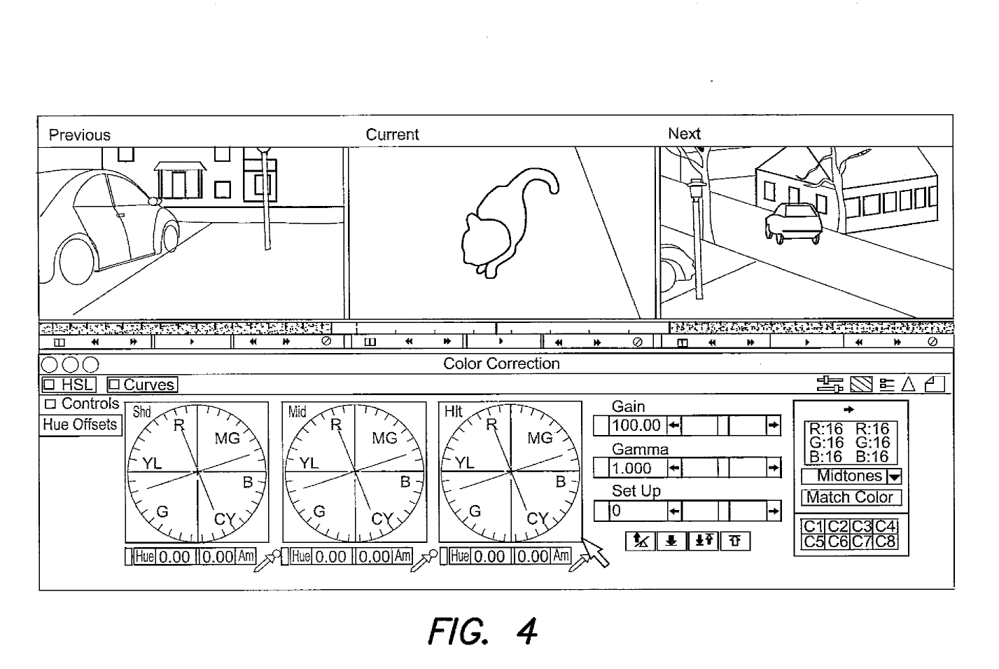

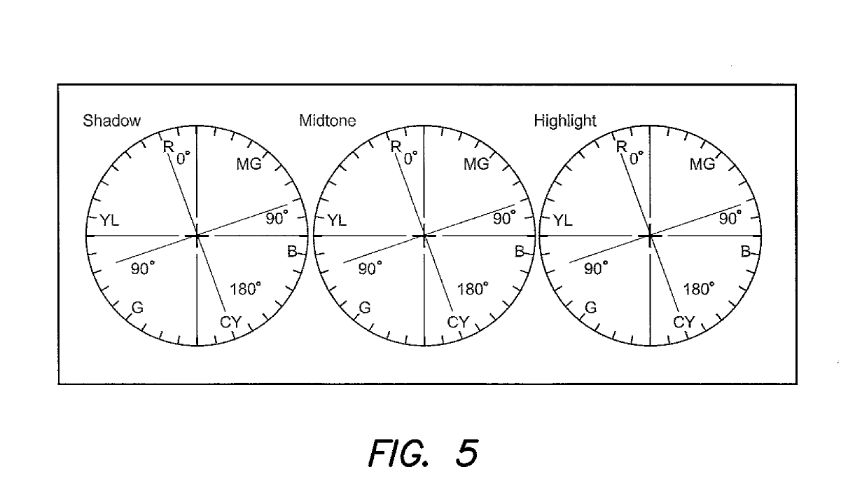

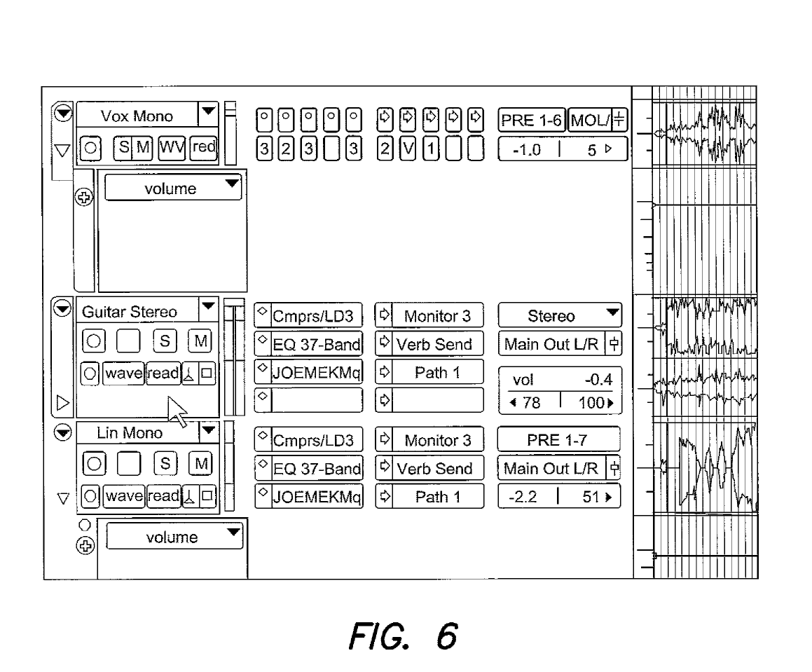

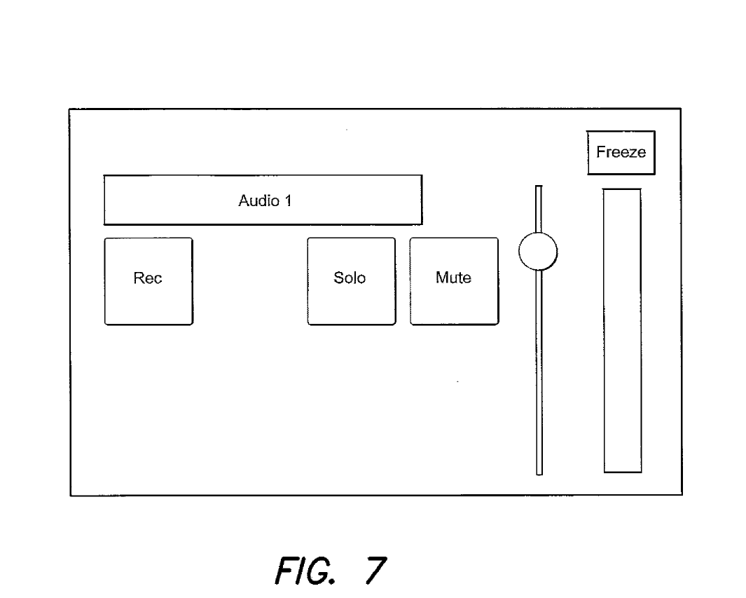

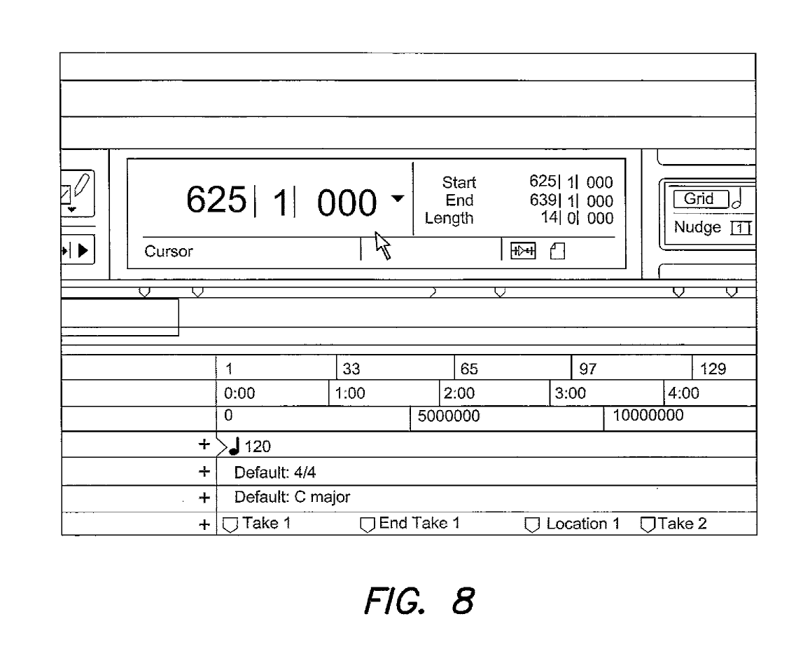

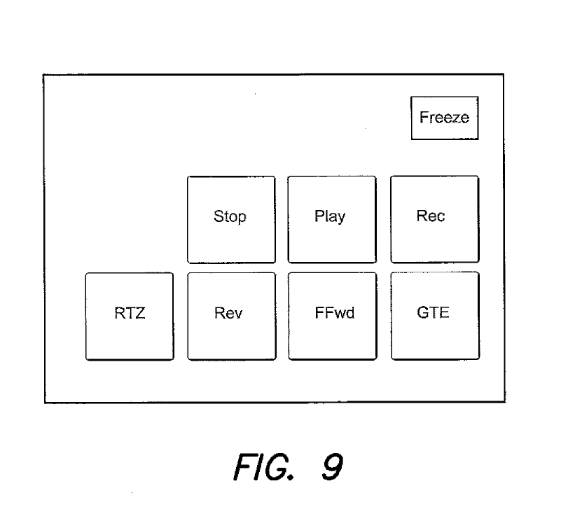

Another way of addressing a crowded interface or cramped controls is to replicate and enlarge one or more of the media editing system's sets of controls. Using a mobile device such as a tablet computer, a given set of controls can be expanded to fill more screen space on the secondary device than is available on the media editing system itself. For example, when a color correction context is activated (FIG. 4) in a video editing system, the color correction wheels are enabled on the mobile device, as shown in FIG. 5. In another example of replicating and enlarging a tool, a channel control context for a digital audio workstation (FIG. 6) activates a channel control interface on the mobile device (FIG. 7). Similarly, a transport bar context for a digital audio workstation (FIG. 8) activates a corresponding set of controls on the mobile device (FIG. 9).

The editing context on the main system may be defined by the state of the transport bar rather than the position of the mouse. A state-dependent context may activate related functionality on the mobile device that would be useful when the main system is in that state. For example, a stopped transport may activate clip-editing tools and a playing transport may activate mixer controls. Examples of context defining audio tools with corresponding mobile device functionality include the scrubber, pencil, zoomer, smart tool, audio zoom in/out, MIDI zoom in/out, tab to transients on/off, and mirrored MIDI on/off. In a further audio example, when an editor enters a mixing context, the mobile device displays a mix window, which allows a mix to be adjusted from any location within a room, or even outside the room.

A mobile controller may feature input modalities that are not available on the main media editing system. For example, tablet computers often include touch-sensitive displays, accelerometers, GPS capability, cameras, and speech input. By exploiting such features, the functionality of the media editing system may be enhanced when certain contexts are activated. Thus, rather than replicate existing controls of the media editing system, enhanced or new controls may be implemented on the mobile device. For example, when effects are applied to a video composition, it is often necessary to input various effect parameters. On the main video editing interface, such parameters may be entered by selecting parameters with a mouse. On the other hand, on a touch-sensitive mobile device, effect curves may be controlled by touching and dragging various parameter control curves or their control points, providing more flexible and intuitive manipulation of effects. Gestures may be used to input certain pre-defined curves, such as an L-shaped motion to specify an asymptotic curve. In a pencil mode, the user draws an effect curve manually on the mobile device. In addition, individual key frames may be manipulated and selected directly by finger tapping and dragging.

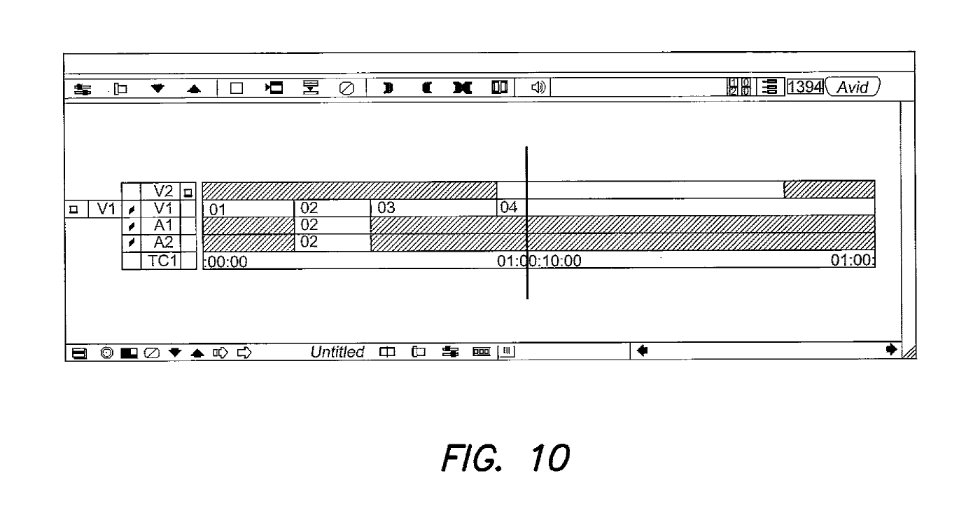

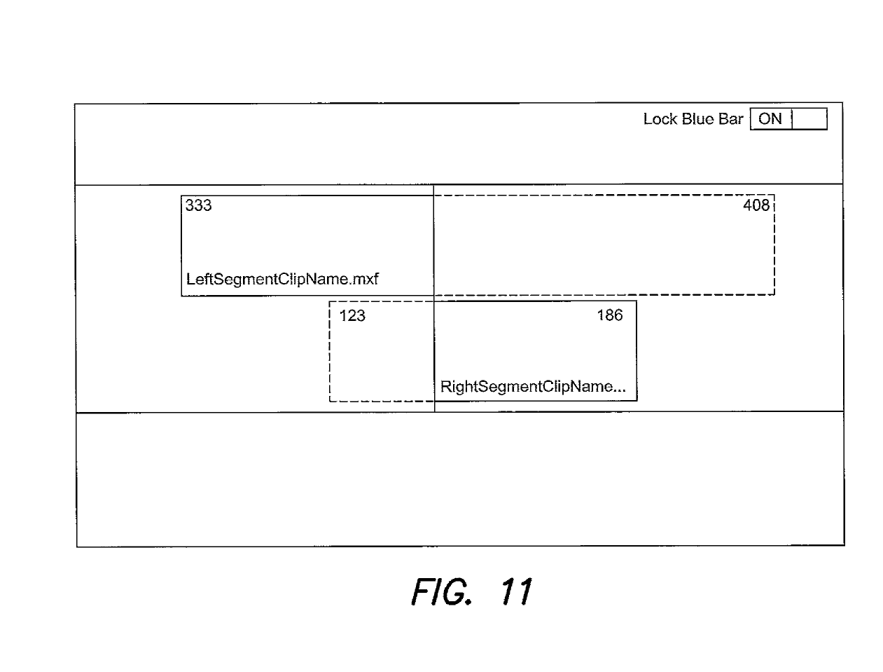

Timeline editing may also define an editing context that activates a corresponding timeline editing, function on the mobile device. A video timeline context is shown in FIG. 10 with a corresponding timeline trim function activated on the mobile device, as illustrated in FIG. 11. Timeline editing functionality enabled on the mobile device may include moving forward and backward in the timeline, zooming in and out of the timeline, trimming the start and end of clips or audio segments, fading in/out, and the use of automation data (audio). In multi-person workflows, a second operator edits a track using the mobile device in trim mode with the freeze control on, while the main operator works on another aspect or component of the composition. In another scenario, a composition is being played on the main editing system, and a second person is viewing a copy on the mobile device. Tapping the device or otherwise specifying a point in the composition brings up a timeline, inserts a locator at the corresponding point, and enables data associated with the locator to be entered. This functionality supports a review and approval workflow.

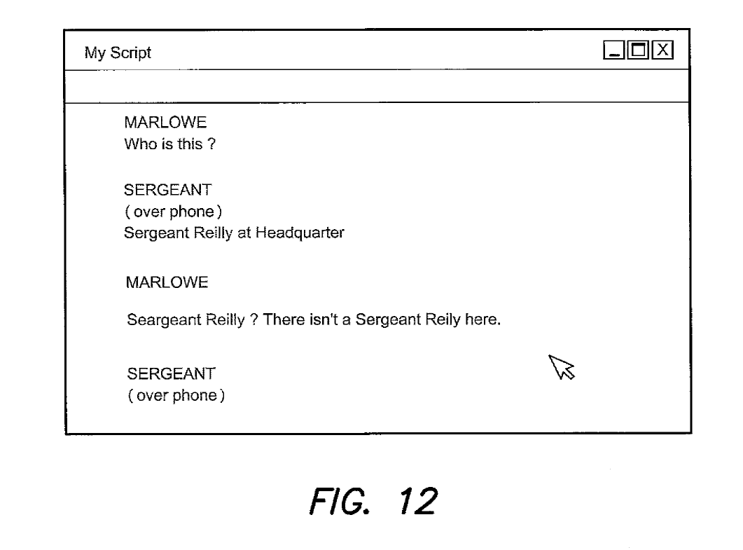

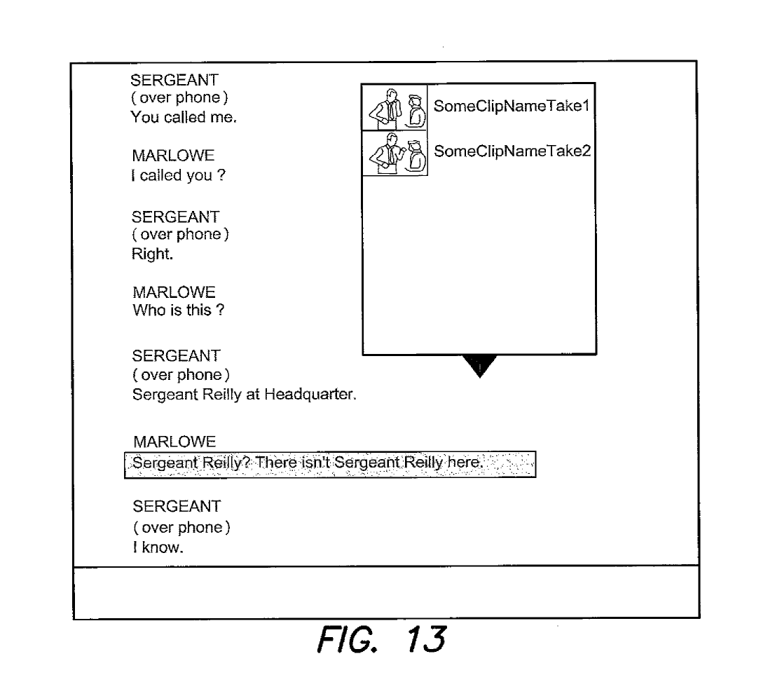

Another media editing context that lends itself to a corresponding functionality on an associated mobile device is video editing with scripts and script-based searching. When the editor activates the script view context (FIG. 12) the mobile device displays the script (FIG. 13), and enables the mobile device user to select a text portion and call up one or more clips that correspond to the script. In a multi-person editing session, one person may use the mobile device in freeze mode to call up the available video clips, preview them, and select the version to be included in the composition being editing, while the second person edits other aspects of the composition using clips previously selected via the mobile device script view.

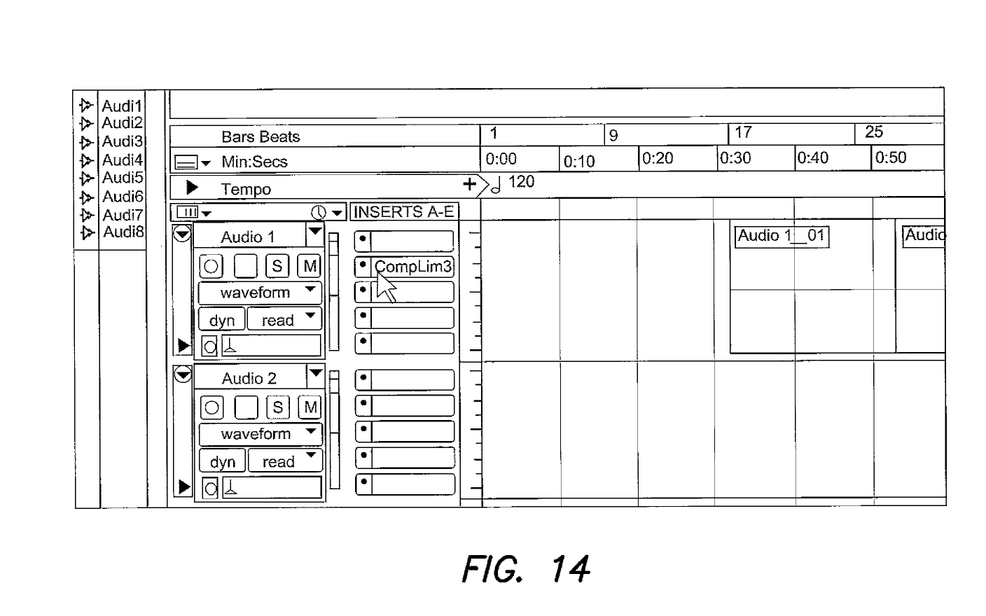

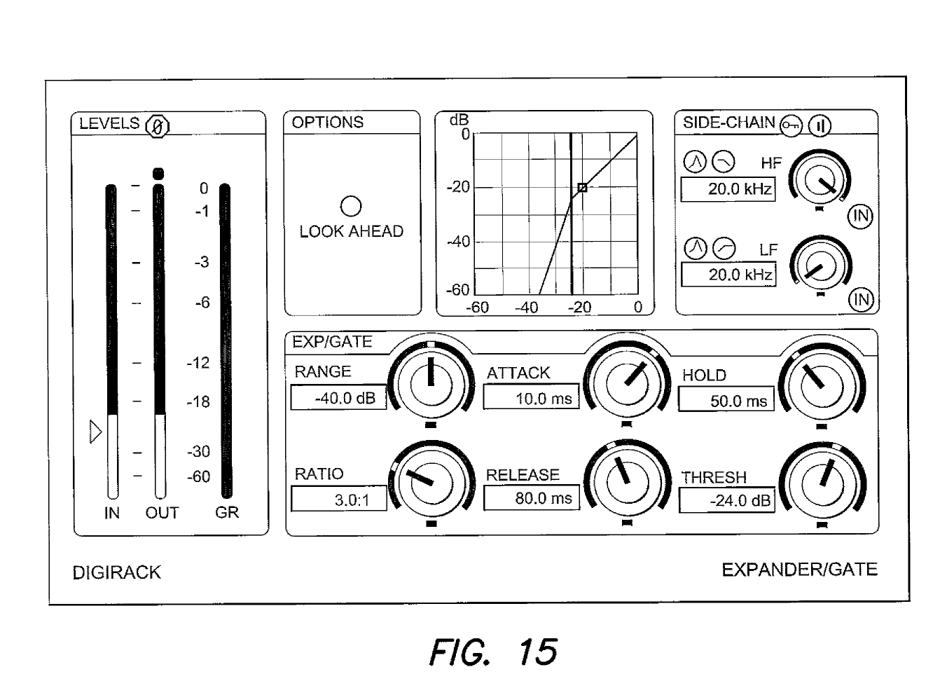

The functionality of video and audio editing systems is commonly extended by means of plug-in software modules. In current systems, the controls for the plug-in functionality are added to the already crowded interfaces of the editing systems, further exacerbating the interface issues described above. Accordingly, another way of using the associated mobile device is to enable plug-in functionality on the mobile device. In some cases, the plug-in would be used by a different person from the editor, making this application useful in both one-user and multi-user workflows. An example in which a compressor/limiter plug-in is used with a digital audio workstation is illustrated in FIGS. 14 and 15. FIG. 14 shows activation of the plug-in functionality in the main interface by selecting the corresponding button to activate the plug-in. FIG. 15 shows the corresponding plug-in UI as it appears on the mobile device.

When the mobile device includes a touch-screen, it is possible to provide improved interfaces that involve controlling more than one parameter. For example, in many audio plug-ins it is desirable for the user to be able to control more than one slider at the same time, which is not generally possible with a mouse. Using multi-touch input on a touch-screen enables such input. For example with an EQ control with two bands, the user can modify the Q-value of a band by pinching/zooming with two fingers, or modify an analog audio warmth or saturation property by a similar action. In another example, the user can use one finger to control two parameters by moving a point in two dimensions, such as gain (X-axis) and frequency (Y-axis). Similarly, it is straightforward to control more than one slider simultaneously using more than one finger, which is not possible using a mouse interface.

Touch input on the mobile device also facilitates additional intuitive, gestural control interfaces for controlling clip properties. Examples include but are not limited to: moving a clip in a timeline with one finger (X-axis); trimming the start of a clip with two fingers near the clip start (X-axis); trimming the end of a clip with two fingers near the clip end; increasing/decreasing volume with two fingers at the center of the clip (Y-axis), panning left-right with two fingers in the center of the clip (X-axis); fading in by holding one finger at the bottom-left edge of the clip and moving the other finger alone the X-axis at the top of the clip near the start; fading out by holding one finger at the bottom right edge of the clip, and moving the other finger in the X-axis at the top of the clip near the end; and zooming into the clip with pinch/zoom gestures.

The various components of the system described herein may be implemented as a computer program using a general-purpose computer system. Such a computer system may be a desktop computer, a laptop, a mobile device such as a tablet computer, a smart phone, or other personal communication device.

Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, liquid crystal displays (LCD), OLED displays, plasma displays, cathode ray tubes, video projection systems and other video output devices, printers, devices for communicating over a low or high bandwidth network, including network interface devices, cable modems, and storage devices such as flash memory, disk or tape. One or more input devices may be connected to the computer system. Example input devices include, but are not limited to, a keyboard, keypad, track ball, mouse, trackpad, pen and tablet, touch screen, microphone, and a personal communication device. The invention is not limited to the particular input or output devices used in combination with the computer system or to those described herein.

The computer system may be a general purpose computer system which is programmable using a computer programming language, a scripting language or even assembly language. The computer system may also include specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. The computer system may be connected to a local network and/or to a wide area network, such as the Internet via a fixed connection, such as an Ethernet network, or via a wireless connection, such as Wi-Fi or Bluetooth. The connected network may transfer to and from the computer system program instructions for execution on the computer, media data, metadata, review and approval information for a media composition, media annotations, and other data.

A memory system typically includes a computer readable medium. The medium may be volatile or nonvolatile, writeable or nonwriteable, and/or rewriteable or not rewriteable. A memory system typically stores data in binary form. Such data may define an application program to be executed by the microprocessor, or information stored on the disk to be processed by the application program. The invention is not limited to a particular memory system. Time-based media may be stored on and input from magnetic or optical discs, which may include an array of local or network attached discs, or received over local or wide area networks from remote servers.

A system such as described herein may be implemented in software or hardware or firmware, or a combination of the three. The various elements of the system, either individually or in combination may be implemented as one or more computer program products in which computer program instructions are stored on storage that is a computer readable medium for execution by a computer, or transferred to a computer system via a connected local area or wide area network. As used herein, such storage, or computer-readable medium is of a non-transitory nature. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A method of providing media editing capability to a user of a mobile device, wherein the mobile device is in communication with a media editing system, the method comprising:
receiving at the mobile device information specifying a current user context of the media editing system, wherein the current user context of the media editing system is defined by a first subset of functionality of the media editing system most recently selected by a user of the media editing system; and
in response to receiving the information specifying the current user context of the media editing system:
activating a second subset of functionality of the media editing system on the mobile device;
displaying on a display of the mobile device a user interface for controlling the second subset of functionality of the media editing system;
via the displayed user interface, receiving a media editing command from the user of the mobile device; and
sending the media editing command from the mobile device to the media editing system, wherein in response to receiving the media editing command, the media editing system performs an action corresponding to the media editing command.

2. The method of claim 1 wherein the second subset of functionality is included within the first subset of functionality.

3. The method of claim 1 wherein at least a portion of the second subset of functionality is not included within the first subset of functionality.

4. The method of claim 3, wherein the mobile device includes a touch-sensitive display, and wherein the portion of the second subset of functionality not included within the first subset of functionality involves touch input by the user of the mobile device.

5. The method of claim 1, wherein the mobile device receives the information specifying content from the media editing system via a direct wireless connection between the media editing system and the mobile device.

6. The method of claim 1, wherein the mobile device receives the information specifying content from the media editing system via a Web server that receives information from the media editing system.

7. The method of claim 1, wherein the media editing system is a video editing system.

8. The method of claim 7, wherein the second subset of functionality of the media editing system includes enabling the user of the mobile device to view information pertaining to a selected item in a bin of the media editing system.

9. The method of claim 7, wherein the second subset of functionality of the media editing system includes enabling the user of the mobile device to select on a timeline representation a cut point between a first clip and a second clip of a video sequence.

10. The method of claim 7, wherein the second subset of functionality of the media editing system includes enabling the user of the mobile device to select a portion of a script corresponding to a video program being edited on the media composition system, wherein selecting the portion of the script causes the media composition to display an indication of one or more clips corresponding to the selected portion of the script.

11. The method of claim 7, wherein the second subset of functionality of the media editing system includes enabling the user of the mobile device to perform color correction operations for a video program being edited on the media composition system.

12. The method of claim 7, wherein the second subset of functionality of the media editing system includes enabling the user of the mobile device to define parameters for applying an effect to a video program being edited on the media composition system.

13. The method of claim 7, wherein the mobile device includes a touch-sensitive display, and wherein the user is able to define the effect parameters by touching and dragging one or more effect control curves.

14. The method of claim 1, wherein the media editing system is a digital audio workstation.

15. The method of claim 14, wherein the second subset of functionality includes channel transport functions.

16. The method of claim 14, wherein the second subset of functionality includes mixing functions.

17. The method of claim 14, wherein the second subset of functionality includes track timeline editing functions.

18. The method of claim 1, wherein functionality of the media editing system is augmented by a plug-in module, and wherein the second subset of functionality includes functionality corresponding to the plug-in module.

19. The method of claim 1, wherein the user interface further includes a freeze control, such that if the current context of the media editing system is changed when the freeze control is selected, the user interface is not changed and the user interface continues to enable the user of the mobile device to control the first-mentioned second subset of functionality of the media composition system from the mobile device.

20. A computer program product comprising:
storage including instructions for a processor to execute, such that when the processor executes the instructions, a process for providing media editing capability to a user of a mobile device is performed, wherein the mobile device is in communication with a media editing system, the process comprising:
receiving at the mobile device information specifying a current user context of the media editing system, wherein the current user context of the media editing system is defined by a first subset of functionality of the media editing system most recently selected by a user of the media editing system; and
in response to receiving the information specifying the current user context of the media editing system:
activating a second subset of functionality of the media editing system on the mobile device;
displaying on a display of the mobile device a user interface for controlling the second subset of functionality of the media editing system;
via the displayed user interface, receiving a media editing command from the user of the mobile device; and
sending the media editing command from the mobile device to the media editing system, wherein in response to receiving the media editing command, the media editing system performs an action corresponding to the media editing command.

21. A mobile device comprising:
a processor for executing instructions;
a network interface connected to the processor;
a user input device connected to the processor;
a display connected to the processor;
a memory connected to the processor, the memory including instructions which, when executed by the processor, cause the mobile device to implement a process for providing media editing capability to a user of the mobile device, wherein the mobile device is in communication with a media editing system, the process comprising:
receiving via the network interface information specifying a current user context of the media editing system, wherein the current user context of the media editing system is defined by a first subset of functionality of the media editing system most recently selected by a user of the media editing system; and
in response to receiving the information specifying the current user context of the media editing system:
activating a second subset of functionality of the media editing system on the mobile device;
displaying on the display a user interface for controlling the second subset of functionality of the media editing system;
via the displayed user interface and the input device, receiving a media editing command from the user of the mobile device; and
via the network interface, sending the media editing command to the media editing system, wherein in response to receiving the media editing command, the media editing system performs an action corresponding to the media editing command.
